(19) United States
(12) Patent Application Publication
(10) Pub. No.: US 2013/0069776 A1
(43) Pub. Date: Mar. 21, 2013

(54) BATTERY POWER REGULATED GPS TRACKING SYSTEM FOR CARGO TRUCKS

(71) Applicant: Greg Haber, Woodbury, NY (US)

(72) Inventor: Greg Haber, Woodbury, NY (US)

(73) Assignee: BABACO ALARM SYSTEMS, INC., Moonachie, NJ (US)

(21) Appl. No.: 13/615,876

(22) Filed: Sep. 14, 2012

Related U.S. Application Data
(60) Provisional application No. 61/536,134, filed on Sep. 19, 2011.

(51) Int. Cl. G08B 1/08

(52) U.S. Cl. 340/463; 340/539.1; 340/539.3

(57) ABSTRACT

The GPS tracking system regulates power supplied by a battery to the system components to transmit an alarm signal in response to detection of motion in the higher level “working” mode. After the motion has ceased for a predetermined time or upon detection of a “low battery” condition, the power consumption regulator will switch to a lower power level “sleep” mode to conserve power. In one embodiment, the system components and a light source are situated within a plastic housing identical to that of the marker light of the vehicle. The housing is designed to replace the marker light and go undetected. When operational, the vehicle electrical system energizes the light source and the GPS tracking system components. It also charges the battery which provides power to the system when the vehicle electrical system is not operational.

### BACKGROUND OF THE INVENTION

1. Field of the Invention

The present invention relates to a GPS tracking devices for use in preventing theft from cargo vehicles with secure enclosures, such as box trucks and trailers, and more particularly, to a power regulated GPS tracking system which in one embodiment is battery powered, and in a second embodiment is provided in a housing as a replacement for the marker light assembly of a vehicle, and is powered by the vehicle's electrical system with a battery back-up.

2. Description of Prior Art Including Information Disclosed Under 37 CFR 1.97 and 1.98

Global Positioning Systems (GPS) are commonly used to determine the location of a vehicle and to track the movement of a vehicle from one location to another. Both portable and vehicle mounted GPS units are known. Such units include the circuitry necessary to communicate with satellites to determine the location of the unit. When used as a tracking device, the GPS unit is also provided with the capability of periodically transmitting the vehicle location information to a system operator or other monitoring facility to track the movement of the vehicle, as the vehicle moves from one location to another, for example, between the place where cargo is loaded into the vehicle and the destination where the cargo is to be unloaded.

A GPS tracking device may be used in various ways to prevent the theft of a truck and/or its cargo. In one example, a motion sensor is employed in conjunction with the GPS unit. Upon detecting motion of the truck, or of a particular cargo container or the like associated with the unit, an alarm signal is transmitted to the system operator indicating that unauthorized movement is occurring. The system operator can then take the necessary action to stop the theft, which can be to alert the police to stop the truck after it has left the secured location or in some cases, to disable the truck motor to prevent the truck from leaving the secured location.

To be an effective deterrent, battery powered GPS units must be able to transmit an alarm signal at any time movement is detected. Thus, battery power must always be available to the components and the battery in the unit must be changed or recharged periodically. Accordingly, the amount of power consumed by the unit is of great importance.

GPS units designed to be vehicle mounted can be powered by the electrical system of the vehicle, when such power is available. However, when power from the vehicle electrical system is not available, for example when the trailer on which the unit is mounted is separated from the tractor normally supplying power, battery back-up power is required if the GPS unit is to remain functional at all times. Thus, power consumption is an issue with vehicle mounted GPS units used for theft prevention, as well.

In either case, a small amount of battery power must always be available to keep at least the motion sensor energized when the unit is operating on battery power. Once motion is detected, it is possible to the increase the amount of power to the unit to operate the GPS locator and the alarm signal transmitter. Thus, by keeping the unit in the relatively low power consumption (“sleep”) mode as much as possible, and increasing the power to the relatively higher power consumption (“work”) mode only when tracking is actually taking place, the life of the battery can be increased, that is, the time interval between battery replacement or recharge can be extended.

One of the aspects of the present invention relates to a system a power management system designed to reduce the battery power consumption in a GPS tracking system used in theft prevention, and can be used by both the battery powered and vehicle powered GPS tracking units with battery backup, to prolong battery life.

It is, therefore, a prime object of the present invention to provide a battery power regulated GPS tracking system for cargo vehicles.

Another way of using GPS units for theft protection is to establish a number of “geo-fenses” which are areas in which the entry or exit of the vehicle will the GPS unit will cause a signal to be sent to the system operator. That will allow the system operator to alert the authorities if the removal of the truck from a geo-fenced area is not authorized, or if it is authorized, to remotely lock the cargo door until the vehicle enters the geo-fenced area at the destination of the vehicle, where the cargo door can be remotely unlocked.

Such a system also records the time when each geo-fenced area has been entered or exited to maintain a log of the vehicle movement. It also allows the system operator to locate the vehicle at any time and even follow the vehicle as it moves from one geo-fenced area to another.

The system can also be configured to provide battery status reports to the system operator, either periodically or upon request. That allows the system operator to monitor the operation of system and have the batteries replaced when necessary.

The GPS unit can be mounted on the vehicle in a manner that is not detectable to a thief by providing it in combination with light sources such as LEDs in an enclosure identical to that of a conventional vehicle marker light. The thief would then not know that the removal of the stolen vehicle from a geo-fenced area has been reported to the system operator or the location of the stolen vehicle is being monitored. Further, if the trailer has been separated from the tractor or the cables between the trailer and the tractor have been cut, such that the trailer has no power from the tractor electrical system, the thief would not be aware that the movement of the trailer is being monitored.

It is, therefore, a prime object of the present invention to provide a battery power regulated GPS tracking system for cargo vehicles.

It is another object of the present invention to provide a battery power regulated GPS tracking system for cargo vehicles that can be a battery powered unit or a vehicle mounted unit with battery back-up.

It is another object of the present invention to provide a battery power regulated GPS tracking system for cargo vehicles which includes a battery power consumption regulator to increase battery life.

It is another object of the present invention to provide a battery power regulated GPS tracking system for cargo vehicles in which the power consumption regulator is actuated in response to the detection of motion to power the system components in the higher power consumption “work’ mode.

It is another object of the present invention to provide a battery power regulated GPS tracking system for cargo vehicles in which the power consumption regulator reduces the power to the system components to the lower power consumption “sleep” mode a given time after motion ceases.

It is another object of the present invention to provide a battery power regulated GPS tracking system for cargo vehicles in which the power consumption regulator switches to the lower power consumption “sleep” mode when the battery output falls below a given level.

It is another object of the present invention to provide a battery power regulated GPS tracking system for cargo vehicles situated in a housing attached to a pre-existing marker light assembly mount of the vehicle to provide a covert installation.

It is another object of the present invention to provide a battery power regulated GPS tracking system for cargo vehicles which is provided in a housing as a replacement for the vehicle marker light assembly of the vehicle, and provides a battery backup for the system, when power from the vehicle electrical system is not available.

It is another object of the present invention to provide a battery power regulated GPS tracking system for cargo vehicles situated in a housing which can be attached to a pre-existing marker light assembly mount of the vehicle and which includes a light source energized by the vehicle electrical system, when power from the vehicle electrical system is available.

It is another object of the present invention to provide a battery power regulated GPS tracking system for cargo vehicles situated in a housing wherein the vehicle marker light assembly mount has a particular configuration and the base of the housing is configured to fit the vehicle marker light assembly mount.

### BRIEF SUMMARY OF THE INVENTION

The above stated objects are achieved by the present invention which relates to a battery power regulated GPS tracking system for cargo vehicles for use in theft prevention. The system includes GPS locator means, a motion sensor for generating an output signal in response to the detection of motion, means for generating and transmitting an alarm signal in response to the output signal, battery means operably connected to power the GPS system components, and means for regulating the power supplied to the system by the battery means in order to reduce power consumption and increase battery life.

The battery power regulating means is connected to receive the output signal. The regulating means includes means responsive to the output signal for causing the battery means to provide power to the system components in the higher power consumption level “work” mode in response to the output signal.

The battery power regulating means includes timing means responsive to the output signal for causing the battery means to provide power to the system components at the lower power consumption level “sleep” mode a given time period after the output signal has ceased.

The battery power regulating means is operably connected to the output of the battery means and further includes means for detecting the level of battery means output and for causing the battery means to provide power to the system components in the lower power consumption level “sleep” mode when the battery means output falls below a predetermined level.

The battery means includes a battery and a voltage pump. Preferably, the battery is a three volt lithium battery.

One preferred embodiment of the system is designed for use on a vehicle having an electrical system and a mount for a marker light assembly normally powered by the vehicle electrical system. The battery power regulated GPS tracking system is situated within a housing. The housing includes means for attaching the housing to the marker light assembly mount on the vehicle. It also includes a light source and means for connecting the light source and the vehicle electrical system to energize the light source, when the housing is attached to the mount.

The battery power regulating means is connected to the vehicle electrical system and to receive the output signal. It includes means responsive to the output signal for causing the battery means to provide power to the system components at the higher power consumption level “work” mode in response to the output signal, if the vehicle electrical system is not operational.

The battery power regulating means includes timing means responsive to the output signal for causing the battery means to power the system components in the lower power consumption level “sleep” mode a given time period after the output signal has ceased.

The battery power regulating means is operably connected to the output of the battery means. It includes means for detecting the level of battery means output and for causing the battery means to power the system components in the lower power consumption level “sleep” mode when the battery means output falls below a predetermined level.

The battery means includes a battery and a voltage pump.

In accordance with another aspect of the present invention, a GPS tracking system is provided for use on a vehicle having an electrical system and a mount for a marker light assembly powered by the vehicle electrical system. The system includes GPS locator means, a motion sensor for generating an output signal in response to the detection of motion, means for generating and transmitting an alarm signal in response to the output signal, and battery means operably connected to power the system components, when power from the vehicle electrical system is not available. Means are provided for regulating the power supplied by the battery means to the system components in response to the output signal. The system is situated within a housing. The housing includes means for attaching the housing to the marker light assembly mount of the vehicle, a light source and means for connecting the light source and the vehicle electrical system to energize the light source, when the housing is attached to the vehicle marker light assembly mount.

The battery power regulating means is connected to the vehicle electrical system and to receive the output signal. It includes means responsive to the output signal for causing the battery means to provide power to the system components in the higher power consumption level “work” mode in response to the output signal, if the vehicle electrical system is not operational.

The battery power regulating means includes timing means responsive to the output signal for causing the battery means to power the system components in the lower power consumption level “sleep” mode a given time period after the output signal has ceased.

The battery power regulating means is operably connected to the output of the battery means and includes means for detecting the level of battery means output and for causing the battery means to power the system components in the lower power consumption level “sleep’ mode when the battery means output falls below a predetermined level.

The battery means includes a battery and a voltage pump. The battery is a three volt lithium battery.

In accordance with another aspect of the present invention, a housing is provided for a GPS tracking system adapted for use on a vehicle having an electrical system and a mount for a marker light assembly powered by the vehicle electrical system. The housing includes means for attaching the housing to the marker light assembly mount of the vehicle, a light source, and means for connecting the light source and the vehicle electrical system to energize the light source, when power from the vehicle electrical system is available. The housing also includes GPS locator means, a motion sensor for generating an output signal in response to the detection of motion, means for generating and transmitting an alarm signal in response to the output signal, and battery means operably connected to power to the components of the system, when power from the vehicle electrical system is not available. Means are also provided for regulating the power supplied by the battery means to the system components to reduce power consumption and increase battery life.

The battery power regulating means is connected to receive the output signal and includes means responsive to the output signal for causing the battery means to power the system components in the higher power consumption “work” mode in response to the output signal.

The battery power regulating means includes timing means responsive to the output signal for causing the battery means to power the system components in the lower power consumption level “sleep” mode a given time period after the output signal has ceased.

The battery means includes a battery and a voltage pump. The battery is a three volt lithium battery.

The battery power regulating means is operably connected to the output of the battery means and further comprises means for detecting the level of battery means output and for causing the battery means to power the system components in the lower power consumption level “sleep” mode when the battery means output falls below a predetermined level.

The vehicle marker light assembly mount has a particular configuration. The base of the housing of the battery power regulated GPS system of the present invention is configured to fit the vehicle marker light mount such that the housing can replace the marker light assembly of the vehicle for a covert installation.

### BRIEF DESCRIPTION OF THE SEVERAL VIEWS OF DRAWINGS

To these and to such other objects that may hereinafter appears, the present invention relates to a GPS tracking system for cargo trucks as described in detail in the following specification and recited in the annexed claims, taken together with the accompanying drawings, in which like numerals refer to like parts and in which:

FIG. 1 is a block diagram showing the components of a battery powered embodiment of the battery power regulated GPS tracking system for cargo vehicles of the present invention;

FIG. 2 is a block diagram showing the components of a vehicle marker light assembly replacement embodiment of the battery power regulated GPS tracking system for cargo vehicles of the present invention;

FIG. 3 is a more detailed block diagram showing the components of a vehicle marker light assembly replacement embodiment of FIG. 2;

FIG. 4 is a flow chart of the operation of the embodiment of the battery power regulated GPS tracking system for cargo vehicles of FIG. 1;

FIG. 5 is a flow chart of the operation of the vehicle marker light assembly replacement embodiment of FIG. 2;

FIG. 6 is a perspective view of the vehicle marker light assembly replacement embodiment of FIG. 2;

FIG. 7 is an exploded view of the vehicle marker light assembly replacement embodiment of FIG. 2;

FIG. 8 is an end view of the vehicle marker light assembly replacement embodiment of FIG. 2;

FIG. 9 is a side view of the vehicle marker light assembly replacement embodiment of FIG. 2; and

FIG. 10 is a top view of the vehicle marker light assembly replacement embodiment of FIG. 2.

### DETAILED DESCRIPTION OF THE INVENTION

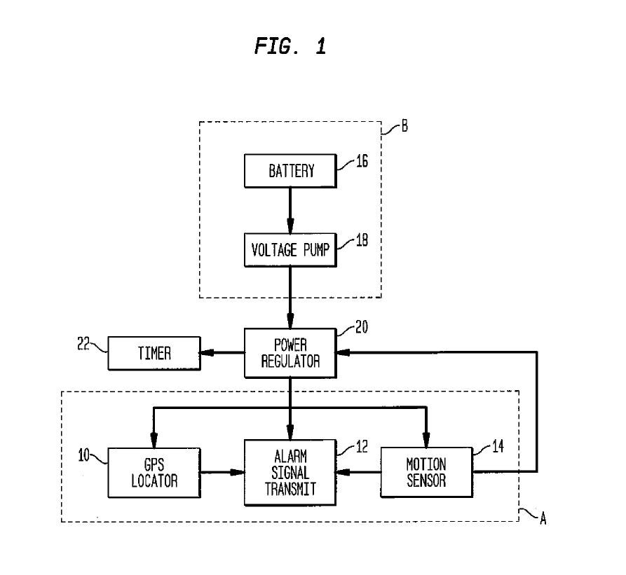

FIG. 1 is a block diagram of a first preferred embodiment of the battery operated GPS tracking system of the present invention designed to be placed anywhere in or on a vehicle, or within a cargo container or the like situated in a compartment of the vehicle. It is portable in the sense that it includes an internal power source in the form of a battery and does not require external electrical power to operate or any connection to the vehicle electrical system.

The GPS system, generally designated A, includes a GPS locator 10 of conventional design which is capable of communicating with satellites to ascertain the position of the system. GPS locator 10 is connected to an alarm signal generating and transmitting circuit 12. Alarm circuit 12 is also connected to a motion sensor 14. Motion sensor 14 generates an output signal when motion is sensed. Alarm circuit 12 will periodically wirelessly transmit an alarm signal to the system operator or other monitoring facility in response to the output signal from the motion sensor. Preferably, that alarm signal will include information about the location of the vehicle, as determined by GPS locator 10 and an indication that motion of the unit has been detected.

Power to GPS locator 10, alarm circuit 12 and motion sensor 14 is provided by a battery means, generally designated B. Battery means B includes a battery 16, preferably a three volt lithium battery, and a voltage pump 18, which functions to increase the voltage level of the battery output.

GPS system A and motion sensor 14 are connected to battery means B through a power consumption regulator circuit 20. Power regulator 20 is connected to a timing circuit 22. The purpose of the power consumption regulator circuit 20 is to control the battery power consumption of the system so as to increase the life of battery 16. Regulator circuit 20 regulates the power consumption of the system by causing the system to switch from its normal relatively high power consumption level “working” mode to a relatively low power consumption level “sleep” mode whenever possible, as described below.

The operation of the system of FIG. 1 is illustrated in the flow chart of FIG. 3. At the start, all components are initialized. The system checks to see if an output signal from motion detector 14 is present. If it is, regulator 20 goes into the higher power consumption level “work” mode, supplying power to GPS locator 10, alarm circuit 12, motion sensor 14 and timing circuit 22 at the higher level provided by voltage pump 18. It also resets the clock of the timing circuit. The alarm circuit will continue to generate and transmit the alarm signal to the GPS operator during the presence of the output signal from the motion sensor, indicating that motion is being detected, and for a given time period after the motion sensor ceases generating the output signal. That time interval can be adjusted as needed.

After the clock reaches the set time period, for example, 15 minutes, the power consumption regulator will switch to the “sleep” mode, and provide power to the motion sensor at a lower power consumption level, which is typically a small fraction of the voltage output of the voltage pump. This causes the alarm signal transmitter, the GPS locator, and timer to power down. However, the regulator will continue to provide the motion sensor with enough power to operate, such that it can generate the output signal if motion is detected. The system will remain in the lower power consumption level “sleep” mode until the output signal from the motion sensor is generated again.

The power consumption regulator 20 also monitors the voltage output of the battery. If the voltage output of the battery falls below a preset level (“low battery”), for example 2.5 volts, the system will automatically go into the lower power consumption “sleep” mode. The system can be configured to provide an audible or visual signal indicating the “low battery” condition or to transmit a “low battery” signal to the system operator indicating that the battery must be replaced.

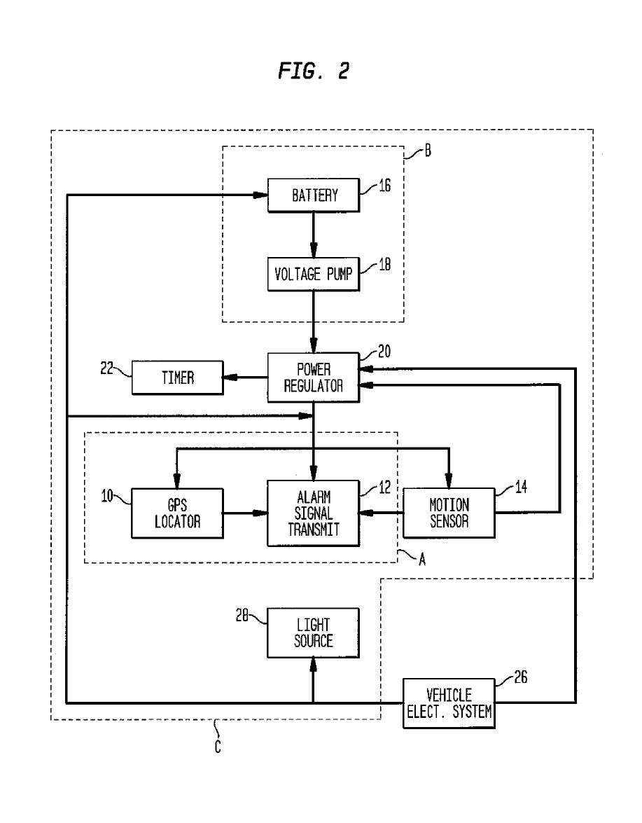

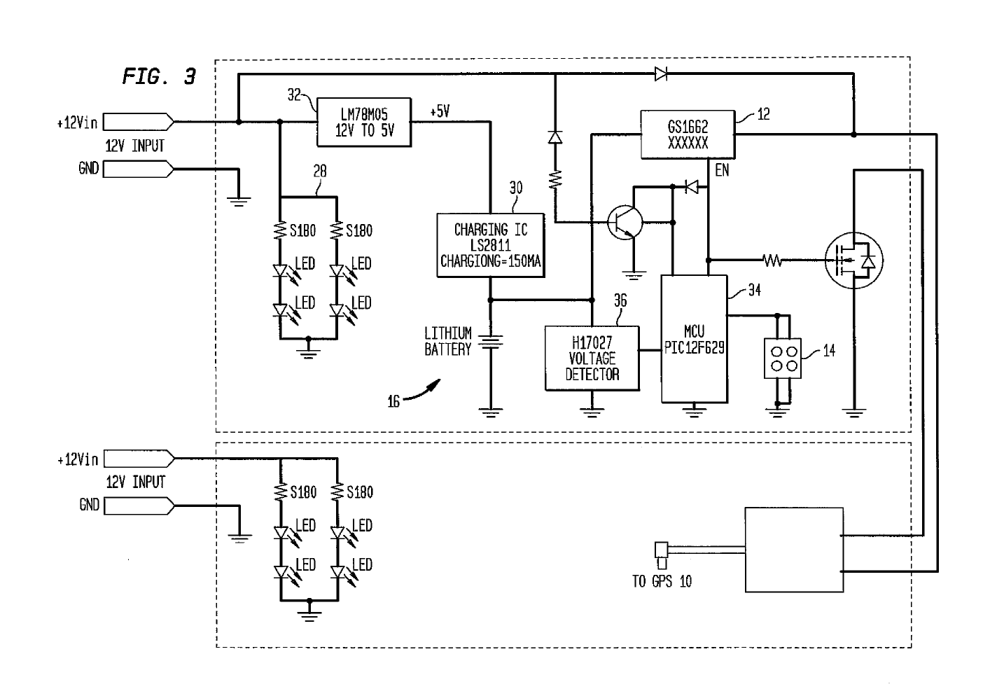

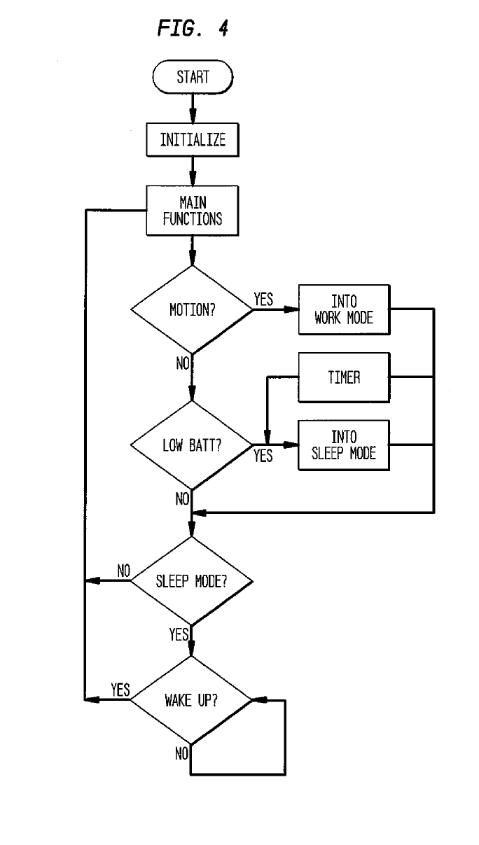

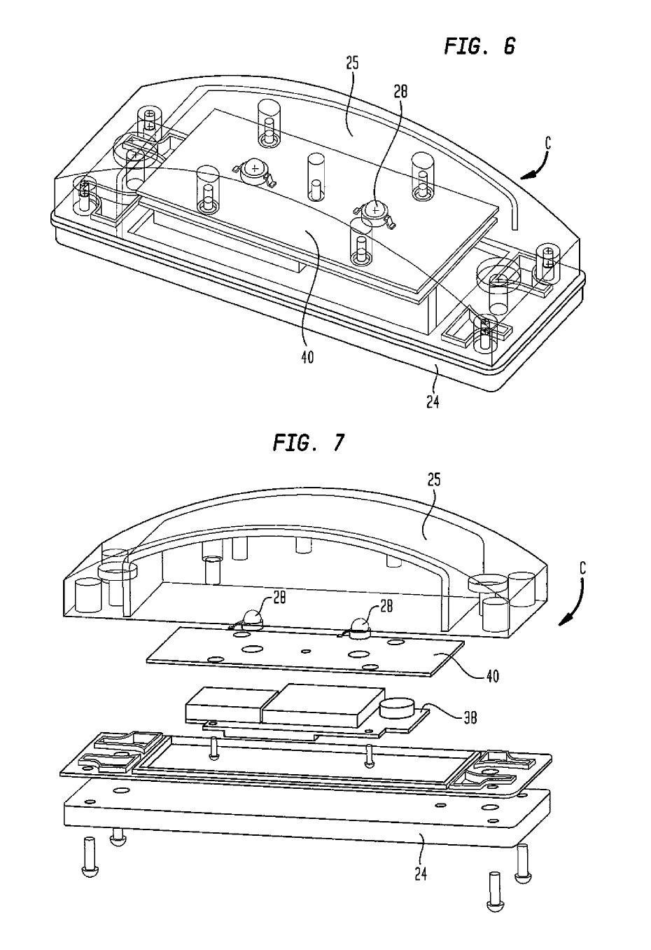

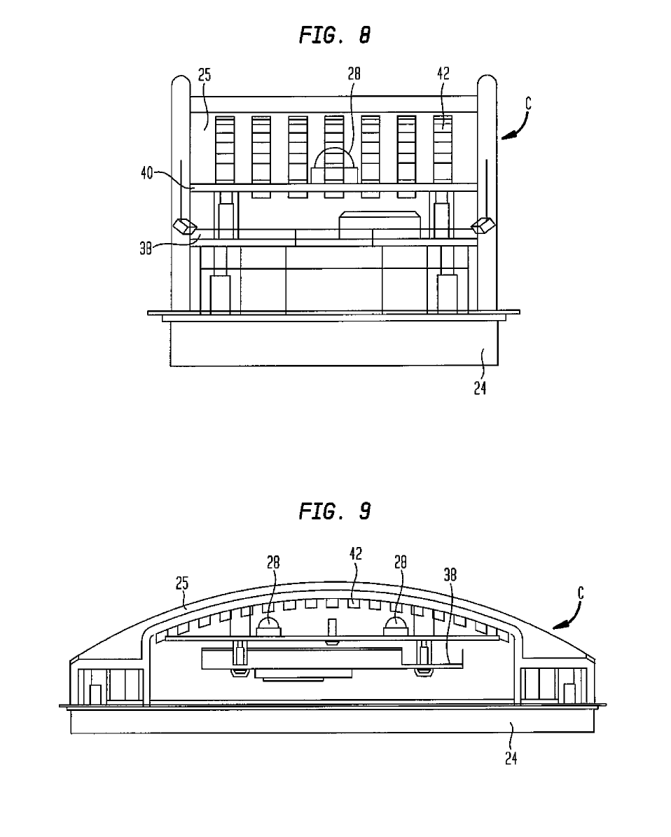

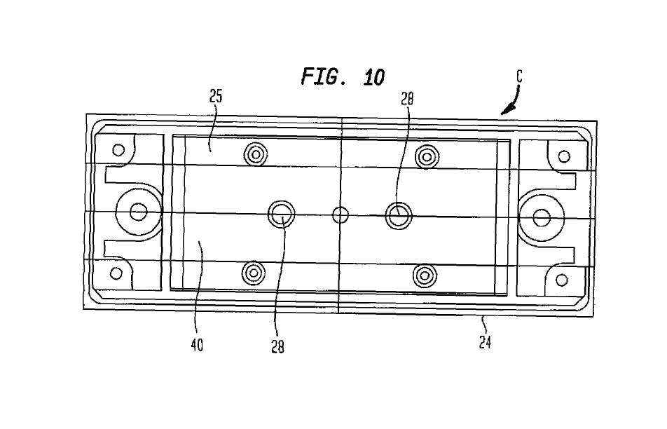

Referring now to FIG. 2, which is a block diagram of the second preferred embodiment of the invention designed to be provided as a replacement for the marker light assembly of the vehicle, it can be appreciated that this embodiment includes the same GPS locator 10, alarm circuit 12, motion sensor 14, battery 16, voltage pump 18, power consumption regulator 20 and timer 22 as in the first preferred embodiment described above. However, in this embodiment, the aforementioned components are situated within a plastic housing, generally designated C, which is configured to replace the marker light assembly of the vehicle and is illustrated in FIGS. 6 through 10.

Housing C is formed of a plastic base 24 and a clear plastic lens cover 25 mounted over the base. Lens cover 25 may be tinted yellow or any other color to match the pre-existing marker lights of the trailer.

Base 24 has the same appearance, configuration, dimensions and electrical connections as the base of the pre-existing marker light assembly of the vehicle. Accordingly, housing C can be substituted for the marker light assembly supplied with the vehicle and the presence of the GPS tracking system embedded within the housing will not be detectable by an observer.

As illustrated on FIGS. 2 and 3, once housing C is received in the mount for the vehicle marker light assembly, the light source 28, preferably formed of one or more LEDs, situated with the housing will be connected to the vehicle electrical system such that the vehicle electrical system will power the components of the GPS tracking system when it is operational, in the same manner as the conventional vehicle marker light. The vehicle electrical system will be operational whenever the vehicle ignition is turned on or the vehicle lights are turned on by placing the ignition switch in the accessory mode. Accordingly, in this embodiment, the primary power for the GPS tracking system will come from the vehicle electrical system when it is operational and the battery will be used only as a backup to power the GPS tracking system when the vehicle electrical system is not operational.

The LEDs which form light source 28 are energized directly by the vehicle electrical system in the same manner as the light source in the vehicle marker light assembly which is replaced by housing C. Thus, housing C with the light source 28 will operate in the exact same manner as the vehicle marker light assembly. While the vehicle electrical system is energized, the battery back-up will not power LEDs 28 in either the “working” mode or the “sleep” mode. However, whenever the vehicle electrical system is providing power to the unit, it will trickle charge the battery through a conventional trickle charging circuit 30, as shown on FIG. 3, which may take the form of a IC LS2811 battery charger controller available from Linkas Tech Inc. or a similar circuit.

FIG. 3 shows that the voltage from the vehicle electrical system is reduced from 12 volts to 5 volts by a transformer 32 which feeds the trickle charge circuit 30. Aside from energizing the LEDs, the vehicle electric system powers the microcontroller 34 which is connected to the motion sensor 14 and to GPS 10. Microcontroller 34 may take the form of a programmable CMOS Flash-based 8-bit microcontroller which includes a 1 channel comparator and 128 bytes of EEPROM memory, available from Microchip Technology Inc. or similar circuit. The microcontroller functions to control the operation of the unit and provides the power regulation function.

Microcontroller 34 is connected to timer 22 and to alarm signal transmitter 12, which may take the form of a SDI Transmitter Circuit, such as GS1662 available from Gennum Corporation. FIG. 3 also shows a voltage detector circuit connected to battery 16 and to the microcontroller such that the microcontroller can monitor the state of battery 16 and switch between the “work” mode and the “sleep” mode as necessary.

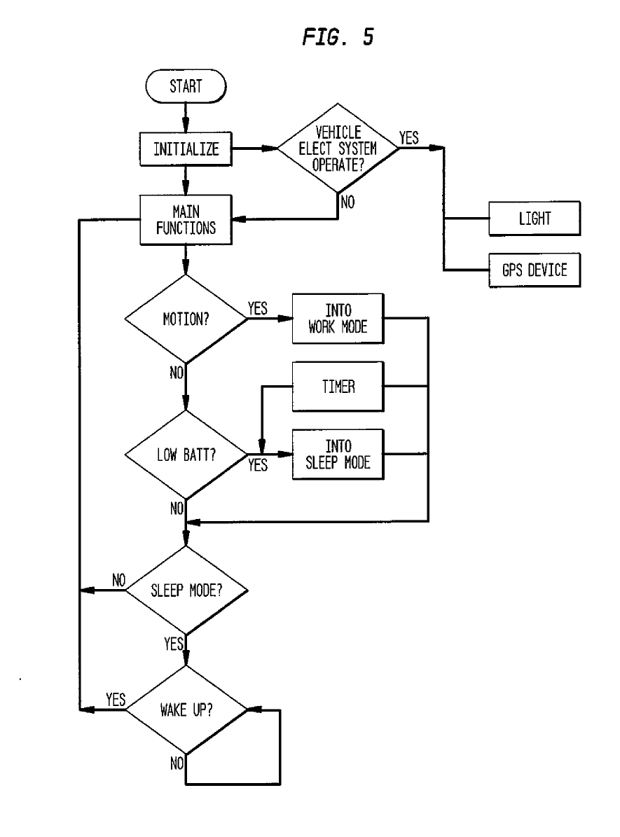

FIG. 5 is a flow chart of the operation of the second preferred embodiment of the invention. This embodiment operates the same as with the battery powered first preferred embodiment except that when the vehicle electrical system is operational, the vehicle electrical system provides power to the system components, including the LEDs 28 and GPS 10. Further, the vehicle electrical system provides power to trickle charge battery 16.

When the electrical system of the vehicle is inoperative, same is detected by voltage detector 36 and the microcontroller causes the system to convert to battery power. The battery means powers the components of the system, except for LEDs 28, and regulates the power consumption switching between the “work” mode and the “sleep” mode in the same manner as in the battery powered first preferred embodiment described previously.

Referring now to FIGS. 6 through 10, housing C includes a transparent lens cover 30 which is attached to a base 24 to enclose and protect the electrical components of the system are mounted from the environment. Base 24 has the exact same configuration as the base of the marker light assembly which it is designed to replace.

Mounted over the top surface of base 24 is circuit board 32 upon which the electrical components of the system are located. Above circuit board 38 is a plate 40 upon which LEDs 28 are situated. Cover 30 preferably includes a light diffusing lens 42 situated over the LEDs so that more even light output can be obtained.

When the housing is mounted in the receptacle for the marker light, the system components are connected to the vehicle electrical system in the same manner as the marker light which the system of the present invention replaces. Thus the system of the present invention is easy to install and replace.

It will now be appreciated that the present invention relates to a battery power regulated GPS tracking system for use in theft prevention which includes a GPS locator, a motion sensor for generating an output signal in response to the detection of motion, means for generating and transmitting an alarm signal in response to said output signal, battery means operably connected to power the system components, and means for regulating the power supplied by the battery means to the system components to reduce power consumption and increase battery life.

The microcontroller which functions as the battery power regulating means is connected to receive the output signal for the motion sensor and is responsive to that output signal to cause the alarm circuit to transmit an alarm signal to the GPS system operator or other person monitoring the location of the vehicle. During that time, the battery means provides power to the system at the higher power consumption level “working” mode. However, after the output signal has ceased for a predetermined time or upon a “low battery” condition, the power consumption regulator will switch to a lower power consumption level “sleep” mode to conserve battery power.

In one preferred embodiment, the system is designed for use on a vehicle having an electrical system and a mount for a marker light assembly powered by the vehicle electrical system. In that embodiment, the GPS tracking system is situated within a housing, which has a base for attaching the housing to the marker light assembly mount, as well as a light source connected to the vehicle electrical system to energize the light source and the GPS tracking system components, when the base is attached to the mount. In this embodiment, the battery serves as a back-up to power the GPS tracking system when the vehicle electrical system is not operational but when the vehicle electrical system is energized, it provides the power to the system and power to trickle charge the battery.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A GPS tracking system for use in theft prevention comprising GPS locator means, a motion sensor for generating an output signal in response to the detection of motion, means for generating and transmitting an alarm signal in response to said output signal, battery means operably connected to power said GPS locator means, said motion detector, and said alarm signal generating and transmitting means, and means for regulating the power supplied by said battery means to said GPS locator means and said alarm signal generating and transmitting means in order to reduce the power consumption of the system and increase battery life.

2. The system of claim 1 wherein said battery power regulating means is connected to receive said output signal and comprises means responsive to said output signal for causing said battery means to power to said GPS locator means and said alarm signal generating and transmitting means at the relatively high power consumption level “work” mode in response to said output signal.

3. The system of claim 2 further comprising timing means responsive to said output signal for causing said battery means to power said GPS locator means and said alarm signal generating and transmitting means at the relatively low power consumption level “sleep’ mode a given time period after said output signal has ceased.

4. The system of claim 1 wherein said battery means includes a battery and a voltage pump.

5. The system of claim 4 wherein said battery is a three volt lithium battery.

6. The system of claim 1 wherein said battery power regulating means is operably connected to the output of said battery means and further comprises means for detecting the level of battery means output and for causing said battery means to power said GPS locator means and said alarm signal generating and transmitting means at the relatively low power consumption level “sleep’ mode when said battery means output level falls below a predetermined value.

7. The system of claim 1 designed for use on a vehicle having an electrical system and a mount for a light assembly powered by said vehicle electrical system, wherein said GPS system is situated within a housing, said housing comprising means for attaching said housing to said light assembly mount of the vehicle, a light source and means for connecting said light source and the vehicle electrical system to energize said light source, when said housing is attached to the mount.

8. The system of claim 7 wherein said battery power regulating means is connected to said vehicle electrical system and to receive said output signal, and comprises means responsive to said output signal for causing said battery means to power said GPS locator means and said alarm signal generating and transmitting means at the higher power consumption level “work” mode after said output signal has been detected, if said vehicle electrical system is not operational.

9. The system of claim 8 further comprising timing means connected to said power consumption regulating means and responsive to said output signal for causing said battery means to power said GPS locator means and said alarm signal generating and transmitting means at the relatively low power consumption level “sleep’ mode a given time period after said output signal has ceased.

10. The system of claim 8 wherein said battery power regulating means is operably connected to the output of said battery means and further comprises means for detecting the level of battery means output and for causing said battery means to power said GPS locator means and said alarm signal generating and transmitting means at the relatively low power consumption level “sleep’ mode when said battery means output level falls below a predetermined value.

11. The system of claim 7 wherein said battery means includes a battery and a voltage pump.

12. A GPS tracking system for use on a vehicle having an electrical system and a mount for a light assembly powered by said vehicle electrical system, said system comprising GPS locator means, a motion sensor for generating an output signal in response to the detection of motion, means for generating and transmitting an alarm signal in response to said output signal, battery means operably connected to power said GPS locator means, said motion detector, and said alarm signal generating and transmitting means, when said vehicle electrical system is not operational, and means for regulating the power supplied by said battery means to said GPS locator means and said alarm signal generating and transmitting means in response to said output signal, wherein said GPS system is situated within a housing, said housing comprising means for attaching said housing to said light assembly mount of the vehicle, a light source and means for connecting said light source and the vehicle electrical system to energize said light source, when said housing is attached to the light assembly mount.

13. The system of claim 12 wherein said battery power regulating means is connected to said vehicle electrical system and to receive said output signal, and comprises means responsive to said output signal for causing said battery means to power said GPS locator means and said alarm signal generating and transmitting means at the relatively high power consumption level “work” mode in response to said output signal, if said vehicle electrical system is not operational.

14. The system of claim 12 further comprising timing means responsive to said output signal for causing said battery means to power said GPS locator means and said alarm signal generating and transmitting means at the relatively low power consumption level “sleep’ mode a given time period after said output signal has ceased.

15. The system of claim 12 wherein said battery power regulating means is operably connected to the output of said battery means and further comprises means for detecting the level of battery means output and for causing said battery means to power said GPS locator means and said alarm signal generating and transmitting means at the relatively low power consumption level “sleep’ mode when said battery means output level falls below a predetermined value.

16. The system of claim 12 wherein said battery means includes a battery and a voltage pump.

17. The system of claim 16 wherein said battery is a three volt lithium battery.

18. A housing for a GPS tracking system adapted for use on a vehicle having an electrical system and a mount for a light assembly powered by said vehicle electrical system, said housing comprising means for attaching said housing to said light assembly mount, a light source, means for connecting said light source and the vehicle electrical system to energize said light source, when said vehicle electrical system is operational, GPS locator means, a motion sensor for generating an output signal in response to the detection of motion, means for generating and transmitting an alarm signal in response to said output signal, and battery means operably connected to power said components of said GPS tracking system, when said vehicle electrical system is not operational, and means for regulating the power supplied by said battery means to said GPS tracking system components to reduce power consumption and increase battery life.

19. The system of claim 18 wherein said battery power regulating means is connected to receive said output signal and comprises means responsive to said output signal for causing said battery means to power said GPS locator means and said alarm signal generating and transmitting means at the relatively high power consumption level “work” mode in response to said output signal.

20. The system of claim 18 further comprising timing means responsive to said output signal for causing said battery means to power said GPS locator means and said alarm signal generating and transmitting means at the relatively low power consumption level “sleep’ mode a given time period after said output signal has ceased.

21. The system of claim 18 wherein said battery means includes a battery and a voltage pump.

22. The system of claim 21 wherein said battery is a three volt lithium battery.

23. The system of claim 18 wherein said battery power regulating means is operably connected to the output of said battery means and further comprises means for detecting the level of battery means output and for causing said battery means to power said GPS locator means and said alarm signal generating and transmitting means at the relatively low power consumption level “sleep’ mode when said battery means output level falls below a predetermined value.

24. The system of claim 18 wherein said housing has a base, the vehicle marker light mount has a particular configuration and said base of said housing is configured to fit the vehicle marker light mount.
